(19) United States
(12) Patent Application Publication
(10) Pub. No.: US 2020/0069091 A1
(43) Pub. Date: Mar. 5, 2020

(54) DRINKING GLASS

(71) Applicants: Daniel Stotesbery, Denver, CO (US); Kacey Stotesbery, Denver, CO (US)

(72) Inventors: Daniel Stotesbery, Denver, CO (US); Kacey Stotesbery, Denver, CO (US)

(21) Appl. No.: 16/560,936

(22) Filed: Sep. 4, 2019

Related U.S. Application Data
(60) Provisional application No. 62/726,891, filed on Sep. 4, 2018.

(51) Int. Cl. A47G 19/22; B01F 3/04; B01F 5/06

(52) U.S. Cl. CPC A47G 19/2233; B01F 3/04794; B01F 2215/0068; B01F 2003/04872; B01F 5/0605

(57) ABSTRACT

The drinking glass as disclosed herein may include a beverage container having a lower base and an upwardly extending outer sidewall terminating in an upper rim having an open mouth of a size and shape for select pour-in reception of a beverage. A visual pour line may be integrally formed flush with a smooth interior surface of the sidewall and integrally formed flush with a smooth exterior surface of the sidewall and provide a visual indication of an amount of liquid within the dinking glass, e.g., 16 or 20 ounces. Moreover, a central projection may extend upwardly from the base and to an interior of the upwardly extending outer sidewall and cooperate therewith to form a generally recessed annular moat therebetween. Also, an aeration tab may extend from the central projection and be positioned to disrupt laminar flow of the beverage when poured into the drinking glass.

### BACKGROUND OF THE INVENTION

The present invention generally relates to a drinking glass. More specifically, the present invention relates to a drinking glass having a pour line integrated into a glass wall during an extrusion molding process that provides a visual indication when a desired quantity of fluid has been poured into the glass (e.g., 16 oz. of a 20 oz. glass), wherein the integral pour line is otherwise not subject to being worn off as a result of repeat use and washing, and that otherwise does not disrupt laminar flow of fluid poured out from or into the glass. The present invention also relates to a drinking glass having one or more aeration tabs positioned within a moat and formed between a glass sidewall and an upwardly and inwardly extending projection, to circulate and aerate liquid at the bottom of the drinking glass.

When beer is poured from a bottle or from a draft faucet, a body of foam known as “head” develops in the glass and floats on top of the beer. While the amount of foam may depend on the type of beer and the process of pouring the beer into the glass, some minimum amount of “head” generally results from the pour. This may cause difficulty in pouring a volume of beer equal to the volume of the glass because the “head” in the glass may occupy space in the glass needed by the liquid beer to fill the glass, i.e., the head effectively prevents the glass from being completely filled with liquid beer. Also, to pour a precise quantity of liquid beer equal to the total volume of the glass, the resulting “head” in the glass must be discarded. This means that some liquid beer is wasted. Moreover, it also takes time for the pourer (e.g., a bartender or the like) to discard the “head” and replace it with more liquid beer before serving.

To speed up the pouring process, the glass may have a greater volume than the amount of beer to be poured, which may provide enough room for both a certain quantity of liquid beer and its “head”. This way, it may be possible to more quickly pour a glass of beer having the desired quantity of liquid therein without the need to consistently discard the “head” at the top of the glass. Although, a glass having a volume greater than that of the desired quantity of beer to be poured (e.g., to provide room for the “head”) may result in inconsistent quantities being served to patrons. This is especially problematic with “glass”-based beer glasses.

To aid in pouring a measured quantity of liquid, glasses known in the art may include indicia or other markings along the sidewalls to indicate the precise volume of liquid when the glass is filled with liquid up to the indicia or marking. For example, U.S. Pat. No. 5,607,078 to Nordberg, the contents of which are herein incorporated by reference in its entirety, discloses a drinking glass having a pair of interior fill lines that provide visual identification when 8 oz. or 10 oz. of liquid have been poured therein. Nordberg also discloses that the drinking glass handle may include an indicator vertically movable thereon along a scale to manually track the number of times the beverage glass has been filled during the day (and the amount of liquid, depending whether the glass is filled with 8 oz. or 10 oz. of liquid). Although, the problem with Nordberg is that the fill lines (e.g., the 8 oz. and 10 oz. indicators) are applied to an interior surface of the beverage glass. Surface fill lines tend to wear off over time with repeat use, especially when cleaned with hot water and/or with a dishwasher. Moreover, applying the fill lines to an interior surface of the glass wall may obstruct adequate viewing of the fill lines when the glass is filled with a beverage. In this respect, Nordberg appears to contemplate using its glass with a clear liquid such as water, but not with liquids that may obstruct viewing of the interiorly applied fill lines. For example, the “head” generated from pouring beer into the Norgberg glass would effectively block viewing of the interiorly applied fill lines, wherein such obstruction would render it difficult, if not impossible, to adequately view the fill lines to determine the actual quantity of liquid beer poured therein.

In another example, U.S. Pat. No. 5,896,990 to Barzana, the contents of which are herein incorporated by reference in its entirety, discloses a beverage glass that includes an 8 oz. fill line applied to an exterior surface of a 10 oz. glass. Similar to Nordberg, Barzana also discloses an indicator system for use in monitoring consumption of water (i.e., a clear liquid), albeit in the form of a rotary indicator having indicia thereon, to indicate the number of times the beverage glass has been filled. Also similar to Nordberg, Barzana also discloses that the fill line indicia be applied to a surface of the glass side wall. As mentioned above, such fill lines have a tendency to wear off over time with repeat use, especially when cleaned with hot water, scrubbed, or washed in a dishwasher.

In another prior art reference, U.S. Publication No. 2011/0192750 to Kokin, the contents of which are herein incorporated by reference in its entirety, discloses a non-transparent beverage glass having inverted indicia applied to the cup wall (or as part of a sleeve) to denote a volume of the beverage measured from top down, which allows customers to identify how much additional room has been reserved for other liquids such as milk, cream, etc. In this case, the indicia basically perform the opposite function to denote the volume of liquid available from the top of the beverage glass as opposed to the amount of liquid that has been poured into the beverage glass. As shown in FIGS. 1-8, Kokin disclose a glass bottom that is flat and fails and it otherwise incapable of aeration.

In other examples, U.S. Pat. No. 2,012,113 to Thompson and U.S. Pat. No. 4,210,141 to Brockman, the contents of which are herein incorporated by reference in their entirety, disclose beverage drinking glasses that include circumferential indicator ledges or inward projections that generally disrupt the continuity of what would otherwise be a relatively smooth and continuous interior glass surface. Such glass wall disruptions can be undesirable in that they are disrupt pouring and/or dispensing of beverage therefrom, which can be especially problematic for carbonated beverages like beer that create “head” when being poured. Moreover, embossed and engraved fill lines may tend to wear down over time with continued repeat use, outside of the fact that they tend to disrupt the smooth laminar flow of beer into or out of the glass. Kokin disclose a glass bottom that is flat and fails and it otherwise incapable of aeration. Thompson and Brockman also fail to disclose aeration tabs within their glass interiors.

There exists, therefore, a need in the art for a glass that includes an integrated pour line that provides a visual indication of the amount or desired quantity of fluid poured therein, that does not wear off with use repeat use, that does not disrupt laminar fluid flow into or out of the glass, and that aerates or circulates liquid at or near the bottom of the drinking glass. The present invention fulfills these needs and provides further related advantages.

### SUMMARY OF THE INVENTION

In one embodiment, the drinking glass includes a beverage retaining container formed by a base at a lower end and an upwardly projecting sidewall extending therefrom and terminating in an upper rim having an open mouth having a size and shape for select pour-in reception of a beverage. A pour line may be formed integrally within the sidewall through intersection of a molten mixture of converged sidewall material during a molding process. Here, the pour line may be positioned at a height below the upper rim to visually demark a lower liquid retaining volume from an upper head accommodating volume within the beverage retaining container and be flush with a smooth interior surface of the sidewall and a smooth exterior surface of the sidewall. Alternatively, or in addition to, the pour line may be a permanently integrated seam within the sidewall of the drinking glass, be abrasion resistant, and otherwise externally visible when a relatively opaque liquid resides within the beverage retaining chamber. Additionally, the pour line may also circumscribe the sidewall and/or the pour line may include multiple pour lines, such as a first forward facing pour line and a second rearward facing pour line.

In other aspects of these embodiments, the base may include a central projection extending upwardly and inwardly away from the sidewall and cooperate therewith to form a generally recessed annual moat therebetween. Here, the central projection may terminate in a generally horizontal circular pushup plate positioned approximately 0.45 inches and 0.55 inches above the base. The central projection and a flat annular plate of the base may also form an angle α between 50 and 70 degrees therebetween; or the base and the sidewall may form an angle β between 85 degrees and 105 degrees. The upwardly projecting sidewall may taper from the upper rim to the base such that a diameter of the sidewall at the upper rim comprises a size approximately 35% to 50% larger than a diameter of the base. Here, the lower liquid retaining volume may include 16 ounces or 20 ounces and the base may have the footprint of a standard 16 ounce pint glass or the footprint of a standard 20 ounce pint glass.

The drinking glass may be made in an extrusion blow molding process such that the drinking glass is made from a substantially transparent plastic polymer material. Here, the drinking glass may be formed into a frusto-conical shape and the sidewall may have a thickness of 0.05 to 0.07 inches.

In another embodiment, the drinking glass may include a beverage retaining chamber having a lower base and an upper outer sidewall terminating in an open mouth having a size and shape for select pour-in reception of a beverage. A central projection may extend upwardly from the base and to an interior of the upper outer sidewall and cooperate therewith to form a generally recessed annular moat therebetween. The central projection may extend upwardly and inwardly from the sidewall to form an angle α with the base between 50 and 70 degrees therebetween. Moreover, at least one aeration tab or a pair of aeration tabs positioned opposite one another and formed along a common seam may extend from the central projection and be positioned to disrupt laminar flow of the beverage when poured into the drinking glass.

In one embodiment, the at least one aeration tab may include a bead extending outwardly from an outer rim of the central projection. Here, the bead may be at least partially positioned within the recessed annular moat and be of a size such that the bead extends over the outer rim and onto a sidewall surface of the central projection. Moreover, the bead may be a relatively hardened residual plastic material formed integral with the central projection from a blow molding process.

In an alternative embodiment, the at least one aeration tab may extend outwardly and slope downwardly from the central projection and the upper outer sidewall to a lower trough within the recessed annular moat and be positioned relatively higher than a flat annular supportive plate of the base. Moreover, such an aeration tab may also slope downwardly and outwardly into the recessed annular moat from the lower trough such that the at least one aeration tab fills at least part of the recessed annular moat.

In another aspect of these embodiments, the drinking glass may also include a relatively horizontal pour line formed integrally within the sidewall through intersection of a molten mixture of converged sidewall material during a molding process. Here, the pour line may be positioned at a height to visually demark a lower liquid retaining volume from an upper head accommodating volume within the beverage retaining chamber.

In another embodiment, the drinking glass as disclosed herein may include a beverage container having a lower base and an upwardly extending outer sidewall terminating in an upper rim having an open mouth of a size and shape for select pour-in reception of a beverage, a visual pour line integrally formed flush with a smooth interior surface of the sidewall and integrally formed flush with a smooth exterior surface of the sidewall, a central projection extending upwardly from the base and to an interior of the upwardly extending outer sidewall and cooperating therewith to form a generally recessed annular moat therebetween, and an aeration tab extending from the central projection and positioned to disrupt laminar flow of the beverage when poured into the drinking glass.

More specifically, the visual pour line may include a relatively horizontal pour line formed by intersection of converging sidewall material and be positioned at a height below the upper rim to visually demark a lower liquid retaining volume (e.g., that includes 16 ounces or 20 ounces) and an upper head accommodating volume within the beverage container. Here, the visual pour line may also be permanently integrated as part of a seam within the sidewall of the drinking glass and be abrasion resistant. To provide better visualization, the pour line may circumscribe the sidewall, which may have a thickness between 0.05 and 0.07 inches.

In another aspect of these embodiments, the aeration tab may include a bead formed integral with the central projection. Here, the bead may be formed of a hardened residual plastic material and have a size and shape that extends the bead into the recessed annular moat. The aeration tab may also be a single aeration tab or a pair of aeration tabs positioned opposite one another and formed along a common seam. Moreover, the central projection and a flat annular plate of the base may form an angle α between 50 and 70 degrees therebetween.

In another embodiment, the drinking glass may include an integral pour line and may be manufactured by a plastic extrusion blow molding process wherein a mold is cut and reassembled so that, during the extrusion process, a thin line in a sidewall of the drinking glass product is formed at the seam between the two molds. The location of the integral pour line along the height of the sidewall may be used as a visual identifier to establish the desired volume of liquid the drinking glass can retain up to the location of the integral pour line, e.g., 16 ounces or 20 ounces. In this respect, the integral pour line may also be positioned below an upper rim of the drinking glass by a sufficient distance to provide additional volume for any “head” that may result from pouring beer or another carbonated beverage into the drinking glass. Given that the pour line is integrated into the plastic sidewall during the extrusion process, the interior sidewall of the drinking glass remains smooth and consistent throughout such that drinking from the glass does not disrupt the laminar flow of liquid out from within. Moreover, the integral pour line remains externally visible and is not susceptible to removal (e.g., during washing or as a result of abrasion or use over time) because the pour line is integrated into the formation of the glass sidewall, and not simply painted or added to an interior or exterior surface of the sidewall after the glass is manufactured.

In another embodiment, the drinking glass disclosed herein may be manufactured by an extrusion blow molding process wherein a portion of the mold is cut and then reassembled such that a circumferential and externally visible integrated pour line is formed into the glass at a seam between the two reassembled mold pieces. The integrated pour line may be externally visible and separate the drinking glass into a lower liquid retaining section (e.g., beer) and an upper “head” accommodating section that allows pourers to more quickly and accurately pour a desired quantity of carbonated beverage (e.g., beer) into the drinking glass while accommodating the “head” without wasting any poured beverage.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view illustrating a drinking glass having an integral pour line as disclosed herein;

FIG. 2 is a side view of the drinking glass of FIG. 1, further illustrating the integral pour line;

FIG. 3 is a cross-sectional view of the drinking glass taken about the line 3-3 of FIG. 1, further illustrating an internally located upstanding central projection in the base;

FIG. 4 is a perspective view of an alternative drinking glass incorporating a pair of arcuate aeration tabs;

FIG. 5 is a cross-sectional view taken about the line 5-5 in FIG. 4, more specifically illustrating the arcuate aeration tabs of FIG. 4;

FIG. 6 is a perspective view of another drinking glass incorporating a pair of alternative aeration tabs in the form of a bead; and

FIG. 7 is a cross-sectional view taken about the line 7-7 in FIG. 4, more specifically illustrating the arcuate aeration tabs of FIG. 4.

### DETAILED DESCRIPTION OF THE PREFERRED EMBODIMENTS

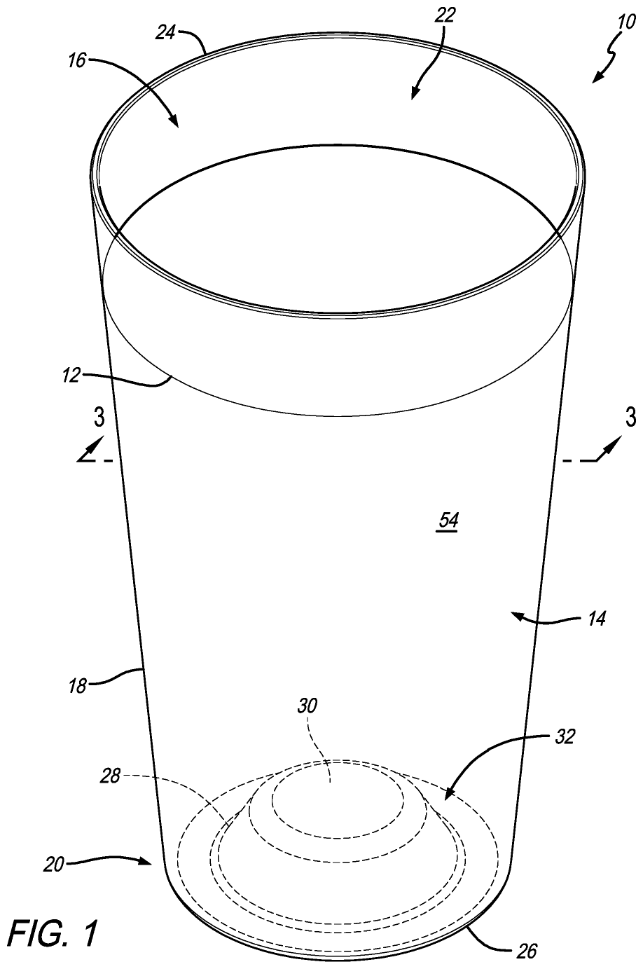

As shown in the exemplary drawings for purposes of illustration, embodiments for a drinking glass with an integral pour line as disclosed herein are generally referred to in FIGS. 1-3 by reference numeral 10. In general, the drinking glass 10 disclosed herein may enable a user (e.g., a bartender or the like) to more accurately and quickly pour what would be considered a “proper” 16 ounce (“oz.”) or 20 oz. pint of beer through use of a permanently formed integral pour line 12 that demarks the drinking glass into two sections, a first lower liquid retaining section 14 and a second upper “head” accommodating section 16. In this respect, the drinking glass 10 may allow for the pouring of a “proper” amount of liquid beer into the liquid retaining section 14 while simultaneously providing room for a “proper” amount of “head” (i.e., the fermented bubbles that form at the top of a beer glass when poured) in the head accommodating section 16. The integrated line 12 provides an abrasion resistant externally visible demarcation that provides for an immediate visual recognition of the amount of liquid, regardless whether clear or opaque, needed to pour a 16 ounce or a 20 ounce beer, without the need to worry about over pouring, under pouring, or wasting beer as a result of dispensing “head” from the top to accommodate the “proper” amount of liquid beer within the glass. Moreover, the dimensions of the drinking glass 10 are sized so that, while accommodating both beer within the liquid retaining section 14 and “head” within the head accommodating section 16, the drinking glass 10 maintains the same footprint as a standard 16 ounce pint or, alternatively, the same footprint as a standard 20 ounce pint glass. Accordingly, the drinking glass 10 as disclosed herein may allow bars and restaurants to offer a 16 oz. beer or a 20 oz. beer in one glass without having to buy separate 16 oz. and 20 oz. glasses, while also cutting down on beer wastage when a bartender must “pour off” the “head” of the beer to achieve a full 16 oz. beer in a traditional 16 oz. glass pint glass.

In one embodiment, the beverage glass 10 may be made or formed from Tritan®, a plastic polymer material manufactured and sold by Eastman Chemical Company of 200 South Wilcox Drive, Building 280, Kingsport, Tenn. 37660. Using Tritan® as the material for the drinking glass 10 may be advantageous in that the Tritan® material is generally resistant to cracking and odorous residues that may otherwise develop inside the drinking glass 10 over time. Although, of course, in other embodiments, the beverage glass 10 may be made from other plastic or polymer-based materials known in the art, or even glass, that may be formed to incorporate the integrated pour line 12 as disclosed herein.

In one embodiment as illustrated in FIGS. 1-3, the drinking glass 10 may have a generally frusto-conical shape as commonly associated with pint beer glasses. Although, in other embodiments, the drinking glass 10 may include other shapes, such as a cylinder commonly associated with beer cans. FIGS. 1-3 also illustrate that the drinking glass 10 may include an upstanding sidewall 18 generally projecting upwardly and outwardly away from a supportive base 20 and terminating in an open mouth 22 circumscribed by a drinking rim 24.

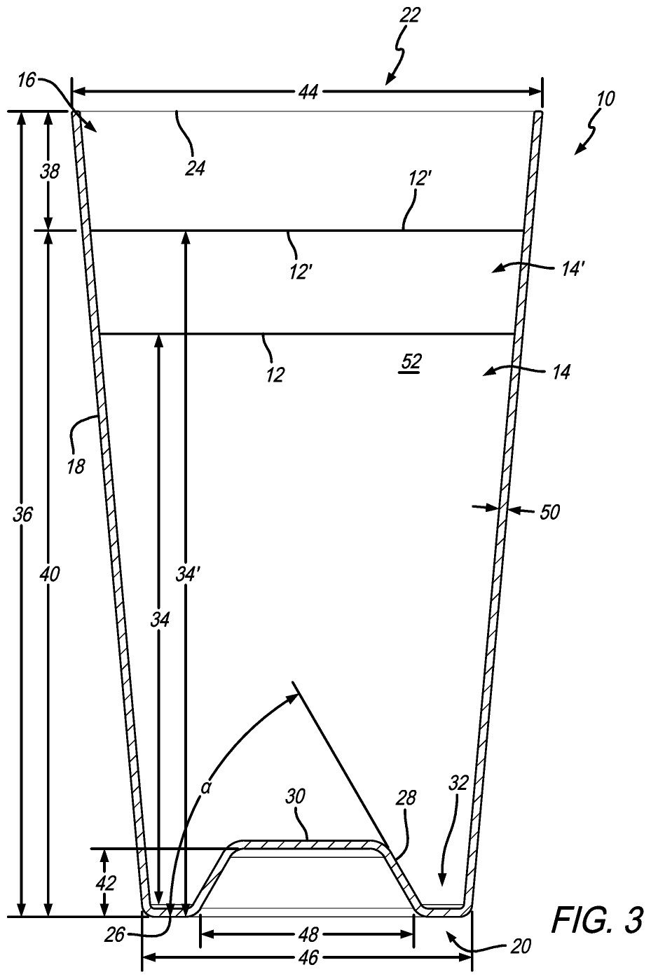

The supportive base 20 may be formed as a generally flat circular plate as known in the art; or, as illustrated in FIGS. 1 and 3, the supportive base 20 may be a two part base 20 that includes a relatively flat annular plate 26 circumscribing an projection 28, thereby forming a profiled base. In this respect, the projection 28 may terminate in a generally horizontal circular pushup plate 30 positioned in an elevated position relative to the annular plate 22. The interior walls of the sidewall 18, the flat annular plate 26, and the projection 28 may form a moat 32 positioned at the bottom of the drinking glass 10, as best illustrated in FIG. 3, that generally circumscribes the projection 28 and the circular pushup plate 30.

As also illustrated in FIGS. 1-3, the drinking glass 10 includes an integrated pour line 12 formed from a portion of the sidewall 18. The integrated pour line 12 may be generally parallel to the flat annular plate 26 and the circular pushup plate 30 of the supportive base 20. Principally, the integrated pour line 12 may be positioned at a height to serve as a visual indicator for a measured volume of liquid less than the total volume of the drinking glass 10. In one embodiment, the height of the integrated pour line 12 along the sidewall 18 of the drinking glass 10 may be selected such that the volume bounded by the sidewall 18, the supportive base 20, and a plane passing through the integrated pour line 12 is equal to 16 ounces, 20 ounces, or equal to any other desired volume of liquid.

In one embodiment, the integrated pour line 12 may generally circumscribe the sidewall 18 of the drinking glass 10. Although, in other embodiments, the integrated pour line 12 may not consistently extend circumferentially around the sidewall 18. For example, the drinking glass 10 may include front and rear facing integrated pour lines 12. In the embodiments disclosed herein, the integrated pour line 12 may include one or more sections each positioned at a consistent height along an exterior surface of the sidewall 18 to denote a specific volume representative of the volume of the liquid retaining section 14. Alternatively, the integrated pour line 12 may be located at different heights along the sidewall 18 of the drinking glass 10. This may allow the drinking glass 10 to be used to quickly and accurately pour different volumes of beverage with a single glass. Here, for example, as illustrated in FIG. 3, the sidewall 18 may include a first integrated pour line 12 at a first height 34 to denote a first liquid retaining section 14 having a first volume (e.g., 16 ounces); and/or the sidewall 18 may include a second integrated pour line 12′ at a second height 34′ indicating a second liquid retaining section 14′ having a second volume (e.g., 20 ounces). In both circumstances, the drinking glass 10 still includes the head accommodating section 16 having a volume sufficient to retain any “head” that may be produced as part of filling the drinking glass 10 with a carbonated beverage, such as beer. This way, a bartender or the like can accurately and quickly pour a 16 ounce or a 20 ounce beverage with a single glass and without having to worry about overflow from the “head”. The ability to do so may allow restaurants, bars, and the like the ability to reduce the number of glasses on-site.

FIG. 3 more specifically illustrates the relative dimensions of one embodiment of the drinking glass 10 as disclosed herein. Specifically, the distance generally orthogonal to the supportive base 20 spanning from the open mouth 22 to the flat annular plate 26 of the supportive base 20 may have a height 36 of between 4.75 inches and 5.75 inches, and specifically 5.290 inches. Moreover, a height 38 generally orthogonal to the supportive base 20 spanning from the open mouth 22 to the integrated pour line 12′ may be between 0.75 inches and 0.95 inches, and specifically 0.863 inches. A height 40 generally orthogonal to the supportive base 20 spanning from the integrated pour line 12′ to the flat annular plate 26 may be between 4.5 inches and 5.5 inches, and may be specifically 5.043 inches. In accordance with the embodiments disclosed herein, the volume of the liquid retaining section 14′ bounded by the sidewall 18 and the integrated pour line 12′ may equal 20 ounces. Moreover, the volume of the head accommodating section 16 bounded by the sidewall 18 and each of the integrated pour line 12′ and an imaginary horizontal plane spanning across the upper rim 24 may be sufficient to retain any resulting “head” without spilling any beer from the drinking glass 10 during pouring. Similarly, the volume of the liquid retaining section 14 bounded by the sidewall 18 and the integrated pour line 12 may equal 16 ounces and, as such, the volume of the head accommodating section 16 bounded by the sidewall 18 and each of the integrated pour line 12 and the imaginary horizontal plane spanning across the upper rim 24 may certainly be sufficient to retain any resulting “head” without spilling any beer from the drinking glass 10 during pouring.

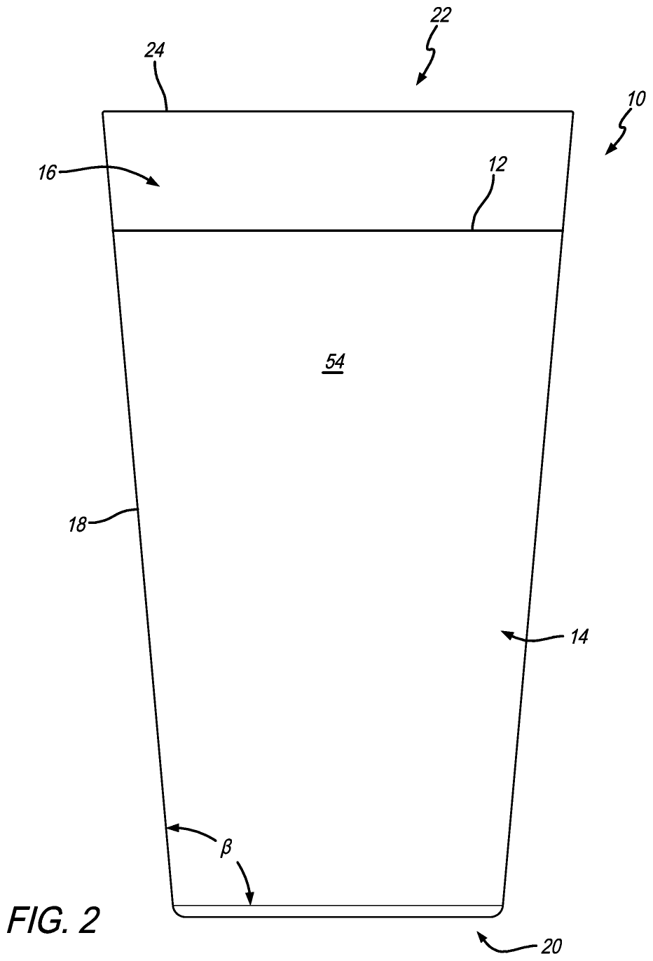

In the embodiment including the flat annular plate 26 and the circular pushup plate 30, a height 42 generally orthogonal to the supportive base 20 spanning from the flat annular plate 26 to the circular pushup plate 30 may be 0.45 inches to 0.55 inches, or more specifically 0.50 inches. Moreover, a diameter 44 of the drinking glass 10 at the open mouth 22 may be between 3.1 inches and 3.8 inches (and specifically 3.442 inches) and taper inwardly therefrom to a diameter 46 at the supportive base 20 bounded by the sidewall 18 of between 2.15 inches and 2.75 inches, and specifically 2.425 inches. From here, the projection 28 may project upwardly and inwardly from the flat annular plate 26 by between 0.375 inches to 4.75 inches (and approximately 0.4285 inches) circumferentially inwardly from the sidewall 18 at the supportive base 20. As such, a diameter 48 of the projection 28 at the supportive base 20 may be between 1.4 inches and 1.75 inches, and more specifically about 1.568 inches. As illustrated in FIG. 3, the projection 28 may extend upwardly and away from the downwardly tapering sidewall 18, thereby terminating in the generally horizontally positioned circular push-up plate 30 having a diameter somewhat less than the diameter 48 of the projection 28. Here, an angle α bounded by the supportive base 20 and the angled upwardly extending projection 28 may be between 50.0 degrees and 70.0 degrees (and specifically about 60.0 degrees) from the horizontal. Moreover, an angle β (FIG. 2) bounded by the sidewall 18 and the flat annular plate 26 of the supportive base 20 may be between 85 degrees and 105 degrees, and specifically approximately 95 degrees. In one embodiment, a thickness 50 of the sidewall 18 may be between 0.05 inches and 0.07 inches, and specifically approximately 0.060 inches.

As to embodiments of the drinking glass 10 having a volume of 20 ounces and including the integrated pour line 12 indicating a volume of 16 ounces, the drinking glass 10 may be filled with precisely 16 ounces of liquid beer, leaving four ounces in the drinking glass 10 for the beer foam in the head accommodating section 16. In contrast, a prior art 16-ounce glass may not allow for pouring precisely 16 ounces of liquid beer, as the head of the beer resulting from the pour typically always occupies a portion of the 16-ounce volume. Also, to fill a prior art 16-ounce glass of beer with precisely 16 ounces of liquid beer, some beer foam, and therefore some liquid beer, must be wasted. As such, use of the drinking glass 10 may not only reduce the time it takes to pour a glass of beer because the pourer need not pour off the “head” to fill the glass, but may also reduce the amount of wasted beer per pour.

The drinking glass 10 may be made by a plastic extrusion blow molding process. To integrate the pour line 12 therein, a mold may be cut and reassembled so that during the extrusion process, a relatively thin integral pour line 12 forms from an exterior sidewall 18 of the drinking glass 10 as a result of a seam formed between two sections of the cut mold. The location of the integral pour line 12 along the height of the sidewall 18 may be used as a visual identifier of the desired volume of liquid the drinking glass 10 can retain, as discussed above. That is, the drinking glass 10 may accommodate 16 oz. or 20 oz. of liquid when the drinking glass 10 is filled up to the integral pour line 12. In this respect, the integral pour line 12 is shown in FIGS. 1-3 positioned below an upper rim 24 of the drinking glass 10 by a sufficient distance to provide additional volume for any “head” that may result from pouring beer or another carbonated beverage into the drinking glass 10, as mentioned above. Given that the pour line 12 is integrated into the plastic sidewall 18 during the extrusion blow molding process, an interior surface 52 of the sidewall 18 of the drinking glass 10 remains smooth and consistent throughout, such that drinking from the glass 10 does not disrupt the laminar flow of liquid out from within. Moreover, the integral pour line 12 remains externally visible and is not susceptible to removal (e.g., during washing or as a result of abrasion and use over time) because the pour line 12 is integrated into the formation of the glass sidewall 18, and not simply painted or added to the interior surface 52 or an exterior surface 54 of the sidewall 18 after the glass is manufactured.

In one embodiment, the integrated pour line 12 may be formed as a relatively small surface bead outwardly extending from the exterior surface 54 of the sidewall 18. Alternatively, the integrated pour line 12 may be flush with the exterior surface 54 such that the sidewall 18 has a substantially smooth interior surface 52 and exterior surface 54. In this embodiment, the integrated pour line 12 remains externally visible even though there are no surface disruptions in the sidewall 18. Any bead or manufacturing flash that may result from the extrusion blow molding process may also be heat treated so the sidewall 18 remains a relatively consistent thickness throughout. Here, the integrated pour line 12 may remain visible as a result of material integration at the seam of the mould, despite the fact that the inner and outer surfaces of the glass sidewall 18 remain smooth throughout.

In additional embodiments, measurement indications may be added to the sidewall 18 of the drinking glass 10 at or near the integrated pour line 12 by way of engraving an interior of the extrusion blow mold with a numerical quantity of liquid the integral pour line represents. For example, since liquid resin may be blown into the engravings in the mold during the extrusion blow molding process, engravings such as “16 oz.” at or near the integral pour line 12 may provide further visual identification that filling the drinking glass 10 to the designated integral pour line 12 would effectively fill the drinking glass 10 with 16 ounces of fluid, or some other identified desired quantity. In alternative embodiments, other forms of indicia may be located on an exterior surface 52 or an interior surface 54 of the sidewall 18, such as by painting, embossing, engraving, or another method as may be known in the art.

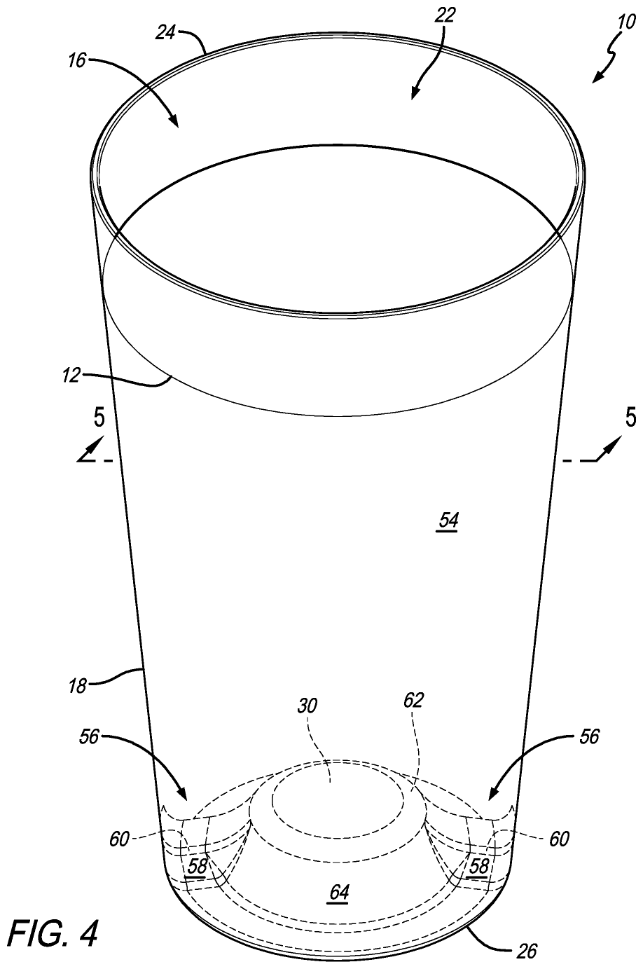

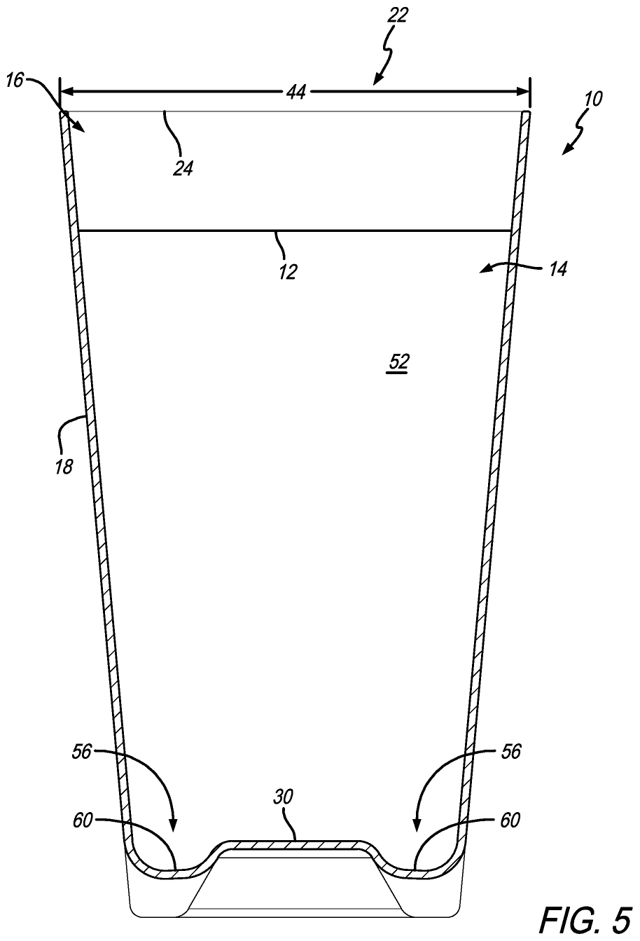

In another aspect of the embodiments disclosed herein, FIGS. 4 and 5 illustrate another embodiment wherein the glass 10 may include a pair of aeration tabs 56 formed in the base 20. Here, each of the aeration tabs 56 include an arcuate surface 58 that slopes down and away from the circular push-up plate 30 and terminates in a lower trough 60 above the flat annular plate 26 of the moat 32 before sloping upwardly into the interior surface 52 of the sidewall 18. As shown best in FIG. 5, since the lower trough 60 of each of the aeration tabs 56 terminates above the flat annular plate 26, the aeration tabs 56 effectively fill a portion of the moat 32. Moreover, the arcuate surface 58 may also slope downwardly and outwardly away from the lower trough 60 and into the moat 32. As such, the geometry of the aeration tabs 56 may permit liquid poured thereover to flow over the lower trough 60 and down into the moat 32 while at the same time the liquid is pushed up on opposite sides of the arcuate surface 58 toward both the sidewall 18 and the circulate pushup plate 30. As such, the geometry of the aeration tabs 56 causes liquid poured into the drinking glass 10 to flow over a relatively larger surface area to desirably draw out carbonation from carbonated beverages such as beer, which can enhance the taste of the carbonated beverage.

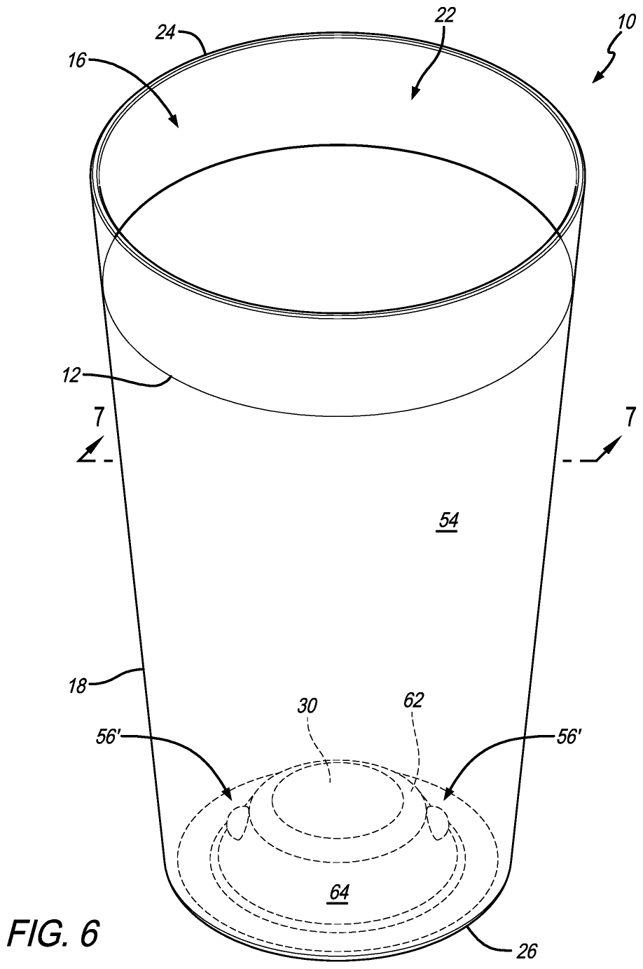

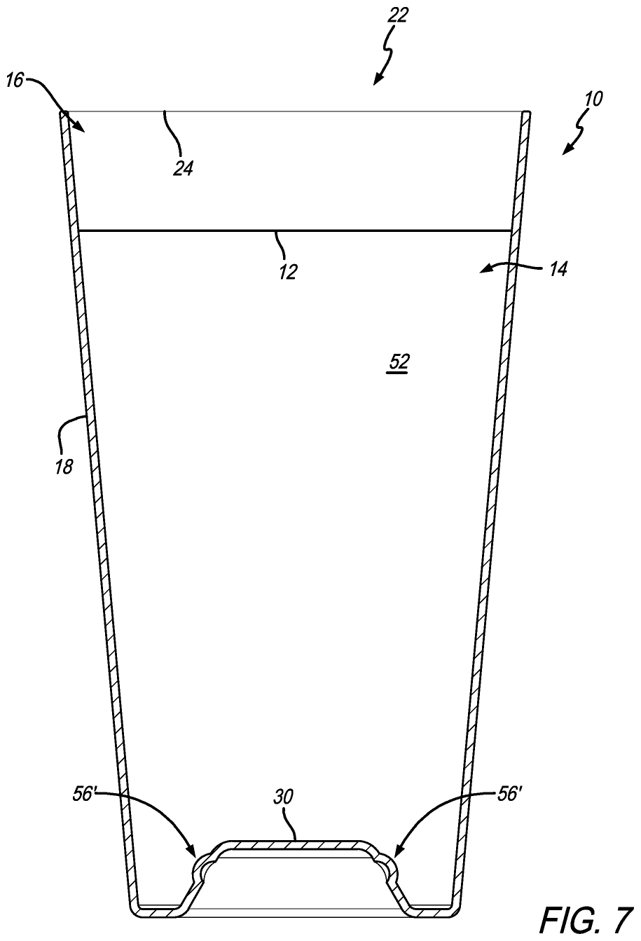

FIGS. 6 and 7 illustrate an alternative set of aeration tabs 56′ in the form of a bead formed from at least a portion of the projection 28. In the embodiment illustrated in FIG. 6, the alternative aeration tabs 56′ extend outwardly from an outer rim 62 of the circular pushup plate 30 and just above or into the volume of the moat 32 (depending on the size of the alternative aeration tabs 56′) formed between the projection 28 and the sidewall 18. Similar to the aeration tabs 56 disclosed above, the alternative aeration tabs 56′ are designed to disrupt laminar flow of beverage into the liquid retaining section 14 to desirably draw out carbonation (and beverage flavor) as a result. The alternative aeration tables 56′ may vary in size, including forming over the outer rim 62 and onto a sidewall surface 64 of the projection 28. The alternative aeration tabs 56′ illustrated in FIG. 6 are shown having a generally rounded structure and may be formed, e.g., as a result of residual molten plastic material within the base 20 during the blow molding process. In other words, the size of the alternative aeration tabs 56′ may depend on the thickness of the material drawn to form the drinking glass 10 during a blow molding manufacturing process. Although, in other embodiments, the aeration tabs 56, 56′ may be formed from etching within opposing halves of a mold such that the aeration tabs 56, 56′ maintain a relatively consistent size and shape in the supportive base 20 that cannot be adjusted with material thickness and curing.

Although several embodiments have been described in detail for purposes of illustration, various modifications may be made without departing from the scope and spirit of the invention. Accordingly, the invention is not to be limited, except as by the appended claims.

What is claimed is:

1. A drinking glass, comprising:
a beverage retaining container formed by a base at a lower end and an upwardly projecting sidewall extending therefrom and terminating in an upper rim having an open mouth having a size and shape for select pour-in reception of a beverage; and
a pour line formed integrally within the sidewall through intersection of a molten mixture of converged sidewall material during a molding process, the pour line being positioned at a height below the upper rim to visually demark a lower liquid retaining volume from an upper head accommodating volume within the beverage retaining container.

2. The drinking glass of claim 1, wherein the base includes a central projection extending upwardly and inwardly away from the sidewall and cooperating therewith to form a generally recessed annual moat therebetween.

3. The drinking glass of claim 2, wherein the central projection terminates in a generally horizontal circular pushup plate positioned approximately 0.45 inches and 0.55 inches above the base.

4. The drinking glass of claim 2, wherein the central projection and a flat annular plate of the base form an angle α between 50 and 70 degrees therebetween.

5. The drinking glass of claim 1, wherein the pour line is flush with a smooth interior surface of the sidewall and flush with a smooth exterior surface of the sidewall.

6. The drinking glass of claim 1, wherein the pour line comprises a permanently integrated seam within the sidewall of the drinking glass.

7. The drinking glass of claim 1, wherein the pour line is abrasion resistant and externally visible when a relatively opaque liquid resides within the beverage retaining chamber.

8. The drinking glass of claim 1, wherein the upwardly projecting sidewall tapers from the upper rim to the base such that a diameter of the sidewall at the upper rim comprises a size approximately 35% to 50% larger than a diameter of the base.

9. The drinking glass of claim 1, wherein the lower liquid retaining volume comprises 16 ounces or 20 ounces and the base comprises a footprint of a standard 16 ounce pint glass or a standard 20 ounce pint glass.

10. The drinking glass of claim 1, wherein the drinking glass comprises a substantially transparent plastic polymer material and the molding process comprises a plastic extrusion blow molding process.

11. The drinking glass of claim 1, wherein the beverage retaining container comprises a frusto-conical shape.

12. The drinking glass of claim 1, wherein the pour line circumscribes the sidewall.

13. The drinking glass of claim 1, wherein the base and the sidewall form an angle β between 85 degrees and 105 degrees therebetween.

14. The drinking glass of claim 1, wherein sidewall comprises a thickness of 0.05 to 0.07 inches.

15. The drinking glass of claim 1, wherein the pour line comprises a first forward facing pour line and a second rearward facing pour line.

16. A drinking glass, comprising:
a beverage retaining chamber having a lower base and an upper outer sidewall terminating in an open mouth having a size and shape for select pour-in reception of a beverage;
a central projection extending upwardly from the base and to an interior of the upper outer sidewall and cooperating therewith to form a generally recessed annular moat therebetween; and
at least one aeration tab extending from the central projection and positioned to disrupt laminar flow of the beverage when poured into the drinking glass.

17. The drinking glass of claim 16, wherein the at least one aeration tab comprises a bead extending outwardly from an outer rim of the central projection.

18. The drinking glass of claim 17, wherein the bead is at least partially positioned within the recessed annular moat.

19. The drinking glass of claim 17, wherein the bead comprises a size extending over the outer rim and onto a sidewall surface of the central projection.

20. The drinking glass of claim 17, wherein the bead comprises a hardened residual plastic material formed integral with the central projection from a blow molding process.

21. The drinking glass of claim 16, wherein the at least one aeration tab extends outwardly and slopes downwardly from the central projection and the upper outer sidewall to a lower trough within the recessed annular moat positioned relatively higher than a flat annular supportive plate of the base.

22. The drinking glass of claim 21, wherein the at least one aeration tab slopes downwardly and outwardly into the recessed annular moat from the lower trough.

23. The drinking glass of claim 21, wherein the at least one aeration tab fills at least part of the recessed annular moat.

24. The drinking glass of claim 16, wherein the at least one aeration tab comprises a pair of aeration tabs positioned opposite one another and formed along a common seam.

25. The drinking glass of claim 16, including a relatively horizontal pour line formed integrally within the sidewall through intersection of a molten mixture of converged sidewall material during a molding process.

26. The drinking glass of claim 25, wherein the pour line is positioned at a height to visually demark a lower liquid retaining volume from an upper head accommodating volume within the beverage retaining chamber.

27. The drinking glass of claim 16, wherein the central projection extends upwardly and inwardly from the sidewall and forms an angle α with the base between 50 and 70 degrees therebetween.

28. A drinking glass, comprising
a beverage container having a lower base and an upwardly extending outer sidewall terminating in an upper rim having an open mouth of a size and shape for select pour-in reception of a beverage;
a visual pour line integrally formed flush with a smooth interior surface of the sidewall and integrally formed flush with a smooth exterior surface of the sidewall;
a central projection extending upwardly from the base and to an interior of the upwardly extending outer sidewall and cooperating therewith to form a generally recessed annular moat therebetween; and
an aeration tab extending from the central projection and positioned to disrupt laminar flow of the beverage when poured into the drinking glass.

29. The drinking glass of claim 28, wherein the visual pour line comprises a relatively horizontal pour line formed by intersection of converging sidewall material.

30. The drinking glass of claim 28, wherein the visual pour line is positioned at a height below the upper rim and visually demarks a lower liquid retaining volume comprising 16 ounces or 20 ounces and an upper head accommodating volume within the beverage container.

31. The drinking glass of claim 28, wherein the central projection and a flat annular plate of the base form an angle α between 50 and 70 degrees therebetween.

32. The drinking glass of claim 28, wherein the visual pour line comprises a permanently integrated seam within the sidewall of the drinking glass.

33. The drinking glass of claim 28, wherein the visual pour line circumscribes the sidewall and the sidewall comprises a thickness between 0.05 and 0.07 inches.

34. The drinking glass of claim 28, wherein the aeration tab comprises a bead formed integral with the central projection.

35. The drinking glass of claim 28, wherein the bead comprises a hardened residual plastic material and has a size and shape extending into the recessed annular moat.

36. The drinking glass of claim 28, wherein the aeration tab comprises a pair of aeration tabs positioned opposite one another and formed along a common seam.
